(19) United States
(12) Patent Application Publication
(10) Pub. No.: US 2016/0176245 A1
(43) Pub. Date: Jun. 23, 2016

(54) APPARATUS AND METHOD FOR CHANGING TPMS SENSOR MESSAGE PREAMBLE BASED UPON MODE

(71) Applicant: Continental Automotive Systems, Inc., Auburn HIlls, MI (US)

(72) Inventors: Matthew D McIntyre, New Baltimore, MI (US); Jean-Christophe Deniau, Fenton, MI (US); Brian Farrell, Troy, MI (US); Yasser Gad, Macomb, MI (US)

(21) Appl. No.: 14/574,628

(22) Filed: Dec. 18, 2014

(51) Int. Cl. B60C 23/04

(52) U.S. Cl. CPC B60C 23/04

(57) ABSTRACT

The air pressure of a tire of a vehicle is sensed. The operational mode of the tire is determined. Based upon the operational mode of the tire, the size of a message preamble is selected. A message to be transmitted to an electronic control unit (ECU) in the vehicle is formed. The message includes the preamble and a payload portion, and the payload portion includes the sensed air pressure. The message is transmitted to the ECU.

### TECHNICAL FIELD

This application relates to tire pressure monitoring system (TPMS) sensors and, more specifically, the transmissions from these devices.

### BACKGROUND

Because of safety regulations, many of today's vehicles feature Tire Pressure Monitoring Systems (TPMS), which measure or estimate the condition of the tire, such as, for example, the inflation air pressure and temperature, and alert the operator about the tire condition.

In these systems, TPMS sensors transmit tire data, such as, for example, inflation pressure and temperature, to vehicle Electronic Control Units (ECUs) in response to changes in measured pressure in the tire when the tire is not in motion, for example when the vehicle is parked. In addition, TPMS sensors installed in spare tires sometimes transmit tire data periodically.

While vehicles are in the off condition the ECUs are often in a sleep-mode state. However, the ECUs wake up periodically to monitor for messages from the TPMS sensors. If a TPMS sensor for a given vehicle is configured to transmit while the vehicle is off condition, then often the ECU is configured to wake up periodically and check whether the TPMS sensor is transmitting, and if so attempt to receive the TPMS message. Accordingly, because the ECU wakes up periodically while the vehicle's battery is not being charged and the ECU operates on electricity supplied from the vehicle's battery, the current consumption of the ECU drains the vehicle's battery.

To reduce the drain effect of the ECU on the vehicle's battery, the number of times the ECU wakes up can be reduced in a given period of time, i.e. to reduce the wake-up frequency of the ECU. However, if the wake-up frequency of the ECU is reduced, the likelihood that the ECU will be checking whether a TPMS sensor is transmitting while a TPMS sensor is actually transmitting will also be reduced. Consequently, TPMS transmissions are missed and this was a significant problem with previous systems.

The above-mentioned problems have led to some general user dissatisfaction with previous approaches.

### BRIEF DESCRIPTION OF THE DRAWINGS

For a more complete understanding of the disclosure, reference should be made to the following detailed description and accompanying drawings wherein:

FIG. 1 comprises a block diagram of a system that changes the TPMS sensor message preamble based upon mode according to various embodiments of the present invention;

FIG. 2 comprises a flow chart of an approach that changes the TPMS sensor message preamble based upon mode according to various embodiments of the present invention;

FIG. 3 comprises a block diagram of a TPMS sensor according to various embodiments of the present invention;

FIG. 4 comprises a block diagram of two TPMS sensor messages including different preambles based upon mode according to various embodiments of the present invention;

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches change the tire pressure monitoring system (TPMS sensor message while the TPMS sensor (or vehicle or wheel) is not in motion so that electronic control unit (ECU) of the vehicle will wake up less frequency but still be able to adequately detect TPMS sensor transmissions. More specifically, the approaches described herein increase the size of the preamble while the sensor is not in motion (e.g., the vehicle is parked) compared to when the vehicle is moving. These approaches allow the ECU to decrease the wake up frequency to detect for TPMS messages, for example, while the vehicle is in the off condition. Consequently, the amount of current consumption is reduced while the vehicle is in off condition (compared to when the vehicle is moving), thus increasing the life of the battery. Advantageously, the present approaches allow the ECU to adequately detect TPMS messages (because of increased preamble size, which increases message length) while at the same time conserving power (because the ECU is waking up less frequently).

In one specific example, while the vehicle is in motion, the TPMS sensors transmit information with the normal preamble, which may consist of 20 bytes of zeros. While the vehicle is in not in motion, the TPMS sensors have an extended preamble, which may consist of 40 to 60 bytes of zeros. Other examples of preamble formats and sizes are possible. For example, the preamble may not be all zeros (i.e., it may include ones).

In many of these embodiments, the air pressure of a tire of a vehicle is sensed and the operational mode of the tire is determined. Based upon the operational mode of the TPMS sensor (or tire or vehicle), the size of a message preamble is selected. A message to be transmitted to an electronic control unit (ECU) in the vehicle is formed. The message includes the preamble and a payload portion, and the payload portion includes the sensed tire air pressure. The message is transmitted to the ECU. Other types of information (e.g., temperature information) may also be included with the payload portion of the message.

In some aspects, the operational mode of the TPMS sensor (or tire or vehicle) is a parked mode or a moving mode. In other aspects, an accelerometer is used to determine whether the tire is in a parked mode or a vehicle mode. In other examples, selecting the size comprises choosing between a first size for when the vehicle is parked and a second size for when the vehicle is moving, the first size being greater than the second size. In some other examples, the preamble comprises a series of logic zeros.

In others of these embodiments, a tire pressure monitoring system (TPMS) sensor includes an interface and a controller. The interface has an input and output. The input is configured to receive the sensed air pressure of a tire of a vehicle and receive movement information indicating the operational mode of the TPMS sensor (or tire or vehicle).

The controller is coupled to the interface and is configured to determine the operational mode of the tire based upon the received movement information. The controller is configured to, based upon the operational mode of the tire, select the size of a message preamble. The controller is configured to form a message to be transmitted to an electronic control unit (ECU) in the vehicle. The message includes the preamble and a payload portion. The payload portion includes the sensed air pressure, and the controller is configured to transmit the message to the ECU via the output.

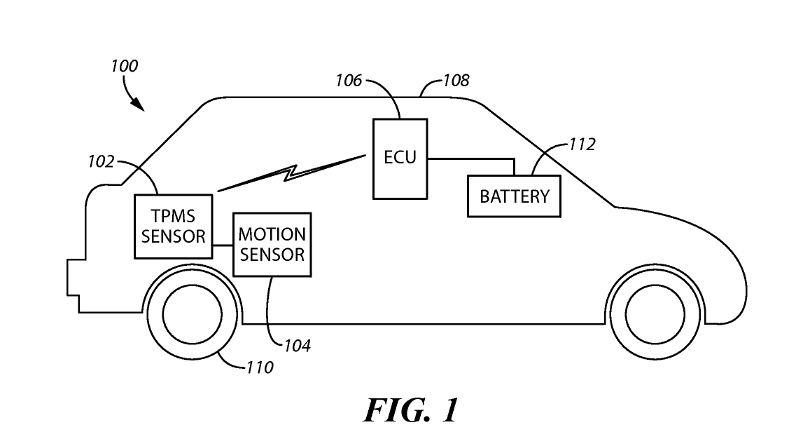

Referring now to FIG. 1, one example of a system 100 that changes the TPMS sensor message preamble based upon operational mode of the TPMS sensor (stationary/parked or moving) is described. The system 100 includes a TPMS sensor 102, a motion sensor 104, an electronic control unit (ECU) (receiver) 106, and a battery 112, all disposed at a vehicle 108 that has tires 110.

The TPMS sensor 102 senses pressure and/or other information (e.g., temperature) from the tire 110. The motion sensor 104 detects movement of the tire 110 and, in one example, may be an accelerometer. Other examples of motion sensors are possible.

The ECU 106 receives messages from the TPMS sensor 102 and processes these messages. For example, when data from the TPMS sensor 102 indicates the air pressure in the tire 110 has reached too low of a level, a warning may be issued to the occupant (e.g., driver) of the vehicle 108. In these regards, the ECU 106 may be coupled to a graphical user interface (GUI) such as a display screen where this information can be presented to the occupant or user of the vehicle 108. The ECU 106 may be coupled to other devices within the vehicle (e.g., the engine system, the braking system, the lighting system to mention a couple of examples) and perform various types of functions (e.g., processing functions, control functions, monitoring functions to mention a few examples) with respect to these other devices. In addition, the ECU 106 may be communicatively coupled (e.g., wired or wirelessly) to other networks external to the vehicle 108 (e.g., cellular communication networks, the internet, wide area networks, to mention a few examples).

The battery 112 powers the ECU 106 and other components of the vehicle 108. However, the TPMS sensor is typically powered by its own battery although other approaches are possible.

A TPMS transmission is made by the TPMS sensor 102 comprises a TPMS message and message that begins with a preamble. This preamble is a predetermined data pattern and is used to signify to the ECU 106 that a TPMS message is incoming. No sensed tire data is included in the preamble. A payload follows the preamble and the payload includes actual measured data (e.g., measured pressure or temperature).

The preamble typically comprises a simple pattern, for example, bytes of 0's. Once a preamble is received by the ECU 106, the ECU 106 typically attempts to listen for payload for a predetermined period of time before giving up.

In one aspect, the length of the payload is governed in part by the frequency of transmissions. While the tire is in motion, and sometimes for some time thereafter, the frequency of transmissions is high is comparison to when the tire is stationary for longer periods of time.

The present approaches extend the existing preamble of the TPMS sensor. This allows the ECU 106 to monitor for TPMS Messages in the same manner when the vehicle is in motion or in the sleep condition. In one advantage, this allows the ECU software to be completed and validated quicker because the TPMS message is not different based on the TPMS sensor condition.

In one example of the operation of the system of FIG. 1, the air pressure of the tire 110 of the vehicle 108 is sensed by the TPMS sensor 102 and the operational mode of the tire is determined by the TPMS sensor 102. The operational mode may be determined from movement information sent from motion sensor 104, which is coupled to the TPMS sensor 102.

Based upon the operational mode of the TPMS sensor 102 (or tire 110 or vehicle 108), the size of a message preamble is selected. A message to be transmitted to the ECU 106 in the vehicle 108 is formed. The message includes the preamble and a payload portion, and the payload portion includes the sensed tire air pressure. The message from the TPMS sensor 102 is transmitted by the TPMS sensor 102 to the ECU 106.

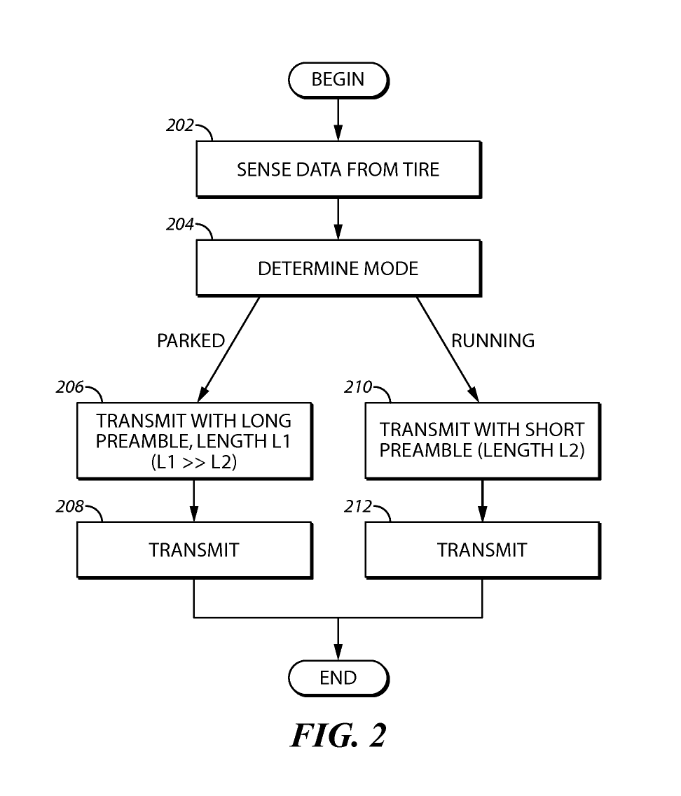

Referring now to FIG. 2, an approach that changes the TPMS sensor message preamble based upon mode is described. At step 202, the air pressure of a tire of a vehicle is sensed. The pressure may be sensed as know by a TPMS sensor. At step 204, the operational mode of the tire is determined. The operational mode may be determined based upon movement information received from a motion sensor. The motion sensor (e.g., an accelerometer) may indicate whether the TPMS sensor (or wheel or vehicle) is turning or otherwise in motion.

Based upon the operational mode of the tire, two paths may be followed. If in parked mode (i.e., the TPMS sensor, vehicle, or tire is stationary with respect to the ground), at step 206, a first size of a message preamble is selected. This first size is greater than a second size where the second size is selected when the TPMS sensor is moving.

At step 208, a message to be transmitted to an electronic control unit (ECU) in the vehicle is formed. The message includes the preamble and a payload portion, and the payload portion includes the sensed air pressure. The message is then transmitted to the ECU.

If in running or moving mode (i.e., the TPMS sensor, vehicle, or tire are moving with respect to the ground), at step 210, a second size of a message preamble is selected. As mentioned, the second size is less than the first size where the first size is selected when the TPMS sensor is not moving.

At step 212, a message to be transmitted to an electronic control unit (ECU) in the vehicle is formed. The message includes the preamble and a payload portion, and the payload portion includes the sensed air pressure. The message is then transmitted to the ECU.

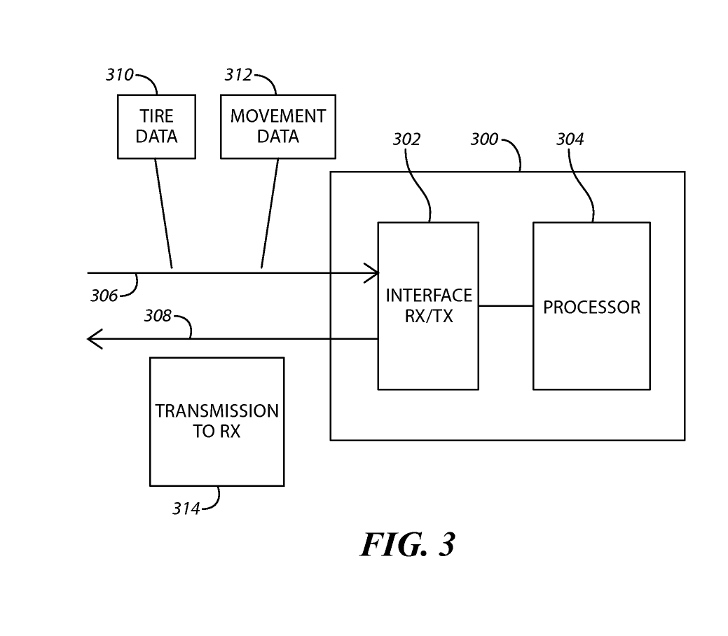

Referring now to FIG. 3, a tire pressure monitoring system (TPMS) sensor includes an interface 302 and a controller 304. The interface 302 has an input 306 and output 308. The interface 302 also includes a receiver and a transmitter. The input 306 is configured to receive data from the tire 310 (e.g., the sensed air pressure of a tire of a vehicle) and receive movement information 312 indicating the operational mode of the tire.

The controller 304 is coupled to the interface 302 and is configured to determine the operational mode of the tire based upon the received movement information 312. The controller 304 is further configured to, based upon the operational mode of the tire, select the size of a message preamble. The controller 302 is also configured to form a message 314 to be transmitted to an electronic control unit (ECU) in the vehicle. The message 314 includes the preamble and a payload portion. The payload portion includes the sensed air pressure, and the controller is configured to transmit the message 314 to the ECU via the output 308.

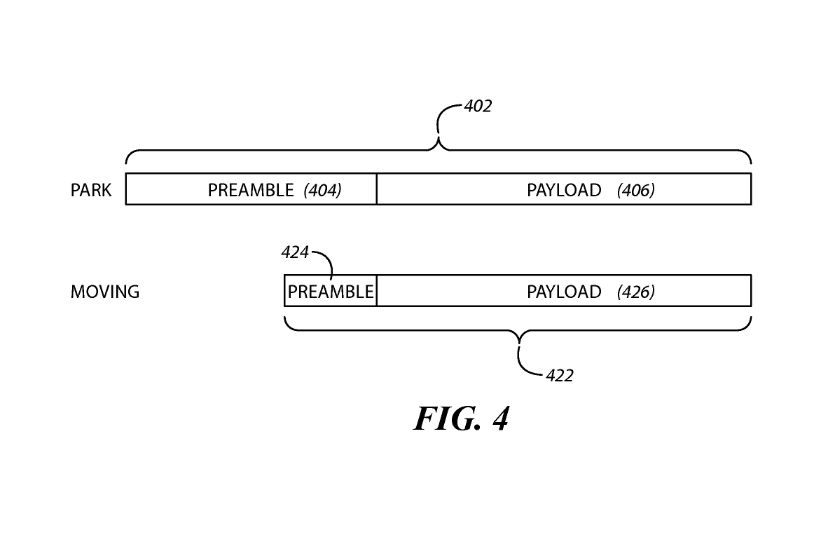

Referring now to FIG. 4, two TPMS sensor messages including different preambles based upon mode are described. A first message 402 includes a first preamble 404 and a first payload portion 406. A second message 422 includes a second preamble 424 and a second payload portion 426.

In one example, the second preamble 424 may consist of 20 bytes of zeros and is transmitted when the vehicle is in motion. While the vehicle is in not in motion, the TPMS sensors has the second (extended) preamble 404, which may consist of 40 to 60 bytes of zeros. Other examples of preamble sizes are possible.

It should be understood that any of the devices described herein (e.g., the tools, the controllers, the receivers, the transmitters, the sensors, any presentation or display devices, or the external devices) may use a computing device to implement various functionality and operation of these devices. In terms of hardware architecture, such a computing device can include but is not limited to a processor, a memory, and one or more input and/or output (I/O) device interface(s) that are communicatively coupled via a local interface. The local interface can include, for example but not limited to, one or more buses and/or other wired or wireless connections. The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory devices described herein can include any one or combination of volatile memory elements (e.g., random access memory (RAM), such as dynamic RAM (DRAM), static RAM (SRAM), synchronous dynamic RAM (SDRAM), video RAM (VRAM), and so forth)) and/or nonvolatile memory elements (e.g., read only memory (ROM), hard drive, tape, CD-ROM, and so forth). Moreover, the memory may incorporate electronic, magnetic, optical, and/or other types of storage media. The memory can also have a distributed architecture, where various components are situated remotely from one another, but can be accessed by the processor.

The software in any of the memory devices described herein may include one or more separate programs, each of which includes an ordered listing of executable instructions for implementing the functions described herein. When constructed as a source program, the program is translated via a compiler, assembler, interpreter, or the like, which may or may not be included within the memory.

It will be appreciated that any of the approaches described herein can be implemented at least in part as computer instructions stored on a computer media (e.g., a computer memory as described above) and these instructions can be executed on a processing device such as a microprocessor. However, these approaches can be implemented as any combination of electronic hardware and/or software.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of transmitting data from a tire pressure monitoring system (TPMS) sensor, the method comprising:
sensing the air pressure of a tire of a vehicle;
determining the operational mode of the tire;
based upon the operational mode of the tire, selecting the size of a message preamble;
forming a message to be transmitted to an electronic control unit (ECU) in the vehicle, the message including the preamble and a payload portion, the payload portion including the sensed air pressure;
transmitting the message to the ECU.

2. The method of claim 1, wherein the operational mode of the tire is a parked mode or a moving mode.

3. The method of claim 2, wherein an accelerometer is used to determine whether the tire is in a parked mode or a vehicle mode.

4. The method of claim 1, wherein selecting the size comprises choosing between a first size for when the vehicle is parked and a second size for when the vehicle is moving, the first size being greater than the second size.

5. The method of claim 1, wherein the preamble comprises a series of logic zeros.

6. A tire pressure monitoring system (TPMS) sensor, comprising:
an interface having an input and output, the input configured to receive the sensed air pressure of a tire of a vehicle and movement information indicating the operational mode of the tire;
a controller, the controller coupled to the interface and configured to determine the operational mode of the tire based upon the received movement information, the controller configured to, based upon the operational mode of the tire, select the size of a message preamble, the controller configured to form a message to be transmitted to an electronic control unit (ECU) in the vehicle, the message including the preamble and a payload portion, the payload portion including the sensed air pressure, the controller configured to transmit the message to the ECU via the output.

7. The TPMS sensor of claim 6, wherein the operational mode of the tire is a parked mode or a moving mode.

8. The TPMS sensor of claim 7, wherein an accelerometer is used to obtain the movement information.

9. The TPMS sensor of claim 6, wherein the controller is configured to choose between a first size for when the vehicle is parked and a second size for when the vehicle is moving, the first size being greater than the second size.

10. The method of claim 6, wherein the preamble comprises a series of logic zeros.

11. A computer usable non-transitory medium having a computer readable program code embodied therein, said computer readable program code adapted to be executed to implement a method of transmitting data from a tire pressure monitoring system (TPMS) sensor, the method comprising:
sensing the air pressure of a tire of a vehicle;
determining the operational mode of the tire;
based upon the operational mode of the tire, selecting the size of a message preamble;
forming a message to be transmitted to an electronic control unit (ECU) in the vehicle, the message including the preamble and a payload portion, the payload portion including the sensed air pressure;
transmitting the message to the ECU.

12. The computer usable non-transitory medium of claim 11, wherein the operational mode of the tire is a parked mode or a moving mode.

13. The computer usable non-transitory medium of claim 12, wherein an accelerometer is used to determine whether the tire is in a parked mode or a vehicle mode.

14. The computer usable non-transitory medium of claim 11, wherein selecting the size comprises choosing between a first size for when the vehicle is parked and a second size for when the vehicle is moving, the first size being greater than the second size.

15. The computer usable non-transitory medium of claim 1, wherein the preamble comprises a series of logic zeros.
